(19) United States
(12) Patent Application Publication
(10) Pub. No.: US 2008/0066309 A1
(43) Pub. Date: Mar. 20, 2008

(54) Fastening board for cooling fins

(76) Inventors: Ying-Lin Hsu, Chung-Ho City (TW); Kun-Feng Tu, Chung-Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/896,650

(22) Filed: Sep. 5, 2007

(30) Foreign Application Priority Data
Sep. 15, 2006 (TW) 95216535

(51) Int. Cl. B23P 15/26

(52) U.S. Cl. 29/890.046; 29/890.03

(57) ABSTRACT

A fastening board for cooling fins includes a board body, a plurality of side boards, and a plurality of fasteners. The side boards are respectively located at the two opposite sides of the board body side. The fasteners are respectively located at the ends of the side boards. The fastening board for cooling fins is used for a tubular radiator to prevent the last cooling fin from coming off the pipe.

### BACKGROUND OF THE INVENTION

1. Field of the Invention

The present invention relates to a fastening board for cooling fins. In particular, this invention relates to a fastening board for cooling fins that the fastening board prevents the cooling fin located at the end of the tubular radiator from coming off the pipe.

2. Description of the Related Art

The tubular radiator of the prior art uses a pipe to pass through a plurality of cooling fins. After the pipe passes through the cooling fins, the redundant pipe that protrudes outside of the cooling fins is clipped and removed, as shown in FIG. 1. The end portion 71 of the pipe 7 has a cone shape. Therefore, there is a gap 9 between the last cooling fin 81 and the pipe 7. The jointing force for the last cooling fin 81 and the pipe 7 becomes weaker. Therefore, the last cooling fin 81 easily comes off the pipe 7 when the tubular radiator is shipped due to vibration.

In order to solve the above problem, a specific cooling fin is manufactured. The specific cooling fin has a small hole that can be passes by the pipe 7 so that the end portion 71 of the pipe 7 tightly joints with the cooling fin. However, because the end portion 71 of the pipe 7 is cone-shaped and its shape is irregular, the jointing force between the specific cooling fin and the pipe 7 is still inadequate. When the tubular radiator is vibrated, the specific cooling fin still comes off the pipe. The problem of the cooling fin 81 easily coming off the pipe 7 still is not solved.

### SUMMARY OF THE INVENTION

One particular aspect of the present invention is to provide a fastening board for cooling fins. It utilizes a plurality of fasteners of the fastening board for cooling fins to fasten the set of cooling fins onto the pipe to prevent the last cooling fin from coming off the pipe.

The fastening board for cooling fins is used for fastening a set of cooling fins onto the pipe. The set of cooling fins are composed of a plurality of cooling fins. There is a plurality of gaps that each gap is located between the two adjacent cooling fins. The fastening board for cooling fins includes a board body covering on the top of the set of cooling fins, a plurality of side boards respectively located at the two opposite sides of the board body, and a plurality of fasteners respectively located at the side boards. The fasteners respectively fasten to the cooling fins.

The present invention also provides another fastening board for cooling fins. The fastening board for cooling fins is used for fastening a set of cooling fins onto the pipe. The fastening board for cooling fins includes a board body covering on the top of the set of cooling fins, two side boards respectively located at the two opposite sides of the board body, and two fasteners respectively located at the end of the two side boards. The board body covers on the top of the set of cooling fins, and the two fasteners fasten to the end of the set of cooling fins.

The present invention also further provides a fastening board for cooling fins. The fastening board for cooling fins is used for fastening a set of cooling fins onto the pipe. The set of cooling fins are composed of a plurality of cooling fins. The two opposite sides of the cooling fins respectively have a plurality of concave ditches. The fastening board for cooling fins includes a board body covering on the top of the set of cooling fins, two side boards respectively located at the two opposite sides of the board body, and a plurality of fasteners respectively located at the sides of the two side boards. The board body covers on the top of the set of cooling fins, and the fasteners fasten to the concave ditches of the cooling fins.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a cross-sectional view of the tubular radiator of the prior art;

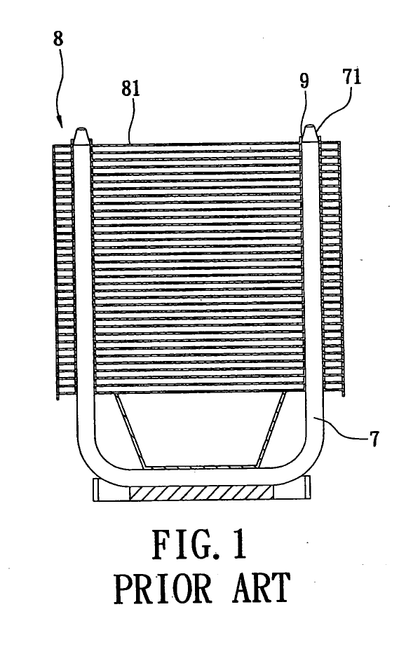

FIG. 2 is a perspective view of the fastening board for cooling fins of the first embodiment of the present invention;

FIG. 3 is a perspective view of the fastening board for cooling fins of the first embodiment of the present invention having openings and cooling holes;

FIG. 4 is a schematic diagram of the fastening board for cooling fins of the first embodiment of the present invention installed on a tubular radiator;

FIG. 5 is a schematic diagram of the fastening board for cooling fins of the second embodiment of the present invention installed on a tubular radiator;

FIG. 6 is a schematic diagram of the fastening board for cooling fins of the third embodiment of the present invention installed on a tubular radiator;

FIG. 7 is a schematic diagram of the fastening board for cooling fins of the fourth embodiment of the present invention installed on a tubular radiator; and

FIG. 8 is a schematic diagram of the fastening board for cooling fins of the fifth embodiment of the present invention installed on a tubular radiator.

### DETAILED DESCRIPTION OF THE PREFERRED EMBODIMENTS

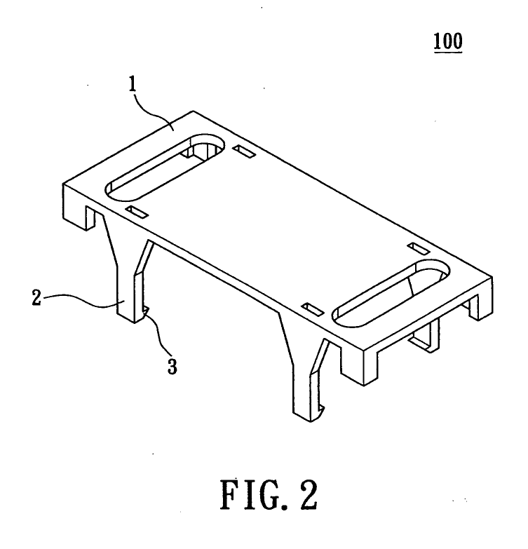

Reference is made to FIG. 2, which shows a perspective view of the fastening board for cooling fins of the first embodiment of the present invention. The fastening board for cooling fins 100 includes a board body 1, a plurality of side boards 2, and a plurality of fasteners 3.

The side boards 2 are respectively located at the two opposite sides of the board body 1. The side boards extend downwards from the sides of the board body 1. The fasteners 3 are respectively located at the end of the side boards 2.

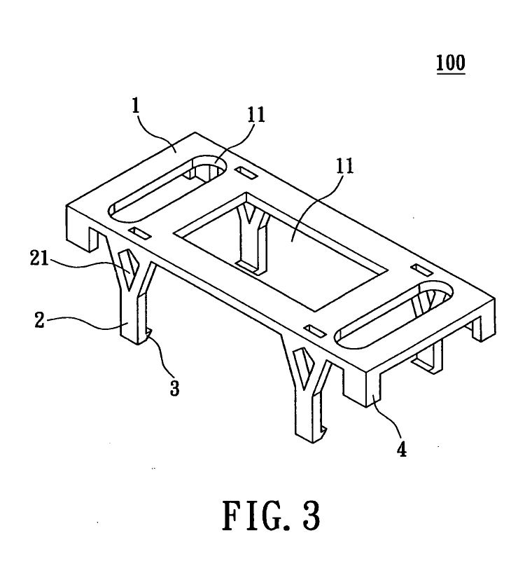

Reference is made to FIG. 3. In order to increase the cooling efficiency, the board body 1 and the side boards 2 of the fastening board for cooling fins 100 has at least one opening 11 and at least one cooling holes 21. The board body 1 extends downwards to form a plurality of fastening portions 4 for positioning the board body 1.

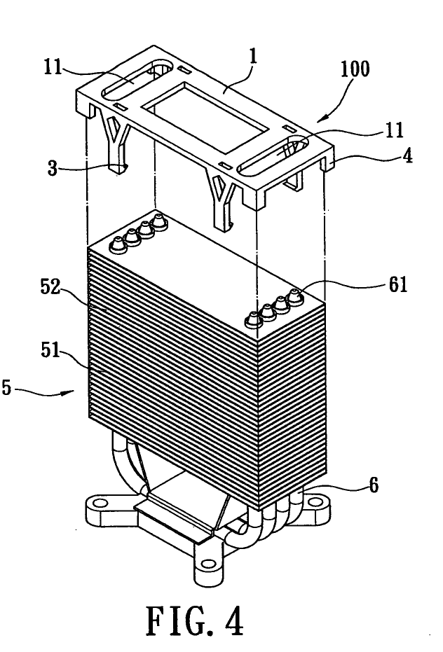

Reference is made to FIG. 4, which shows a schematic diagram of the fastening board for cooling fins 100 installed on a tubular radiator. The tubular radiator includes a set of cooling fins 5 and a plurality of tubes 6. The set of cooling fins 5 are composed of a plurality of cooling fins 51. There are a plurality of gaps 52 that each gap is located between the two adjacent cooling fins 51. The tubes 6 pass through the set of the cooling fins 5. The end portions 61 of the tubes 6 exposes to the set of cooling fins 5.

The board body 1 of the fastening board for cooling fins 100 covers on the top of the set of cooling fins 5. The end portions 61 of the tubes 6 pass through the openings 11 so that the board body 1 is close to the top of the set of cooling fins 5. The fastener 3 locks to the gap 52 of the cooling fins 51 so that the cooling fins 51 do not come off the tubes 6. The fastening portions 4 wedge to the sides of the set of cooling fins 5 so that the board body 1 is firmly located at the set of cooling fins 5.

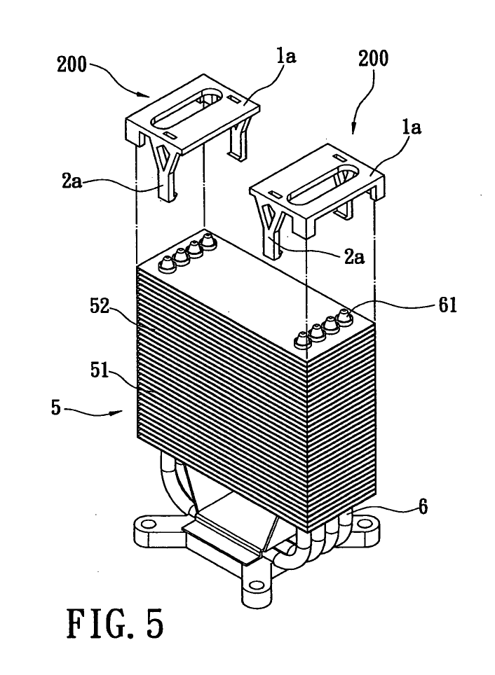

Reference is made to FIG. 5, which shows the fastening board for cooling fins of the second embodiment of the present invention. The difference between the second embodiment and the first embodiment is that the board body 1a of the fastening board for cooling fins 200 does not fully cover on the top of the set of cooling fins 5. The board body 1a of the fastening board for cooling fins 200 merely covers on one side of the top of the set of cooling fins 5. The quantity of the side board 2 is two that are respectively located at two opposite sides of the board body 1a. In this embodiment, there are two the fastening boards for cooling fins 200 respectively wedged to the two sides of the top of the set of cooling fins 5. The area of the set of cooling fins 5 covered by the fastening boards for cooling fins 200 is decreased so that the cooling efficiency increases.

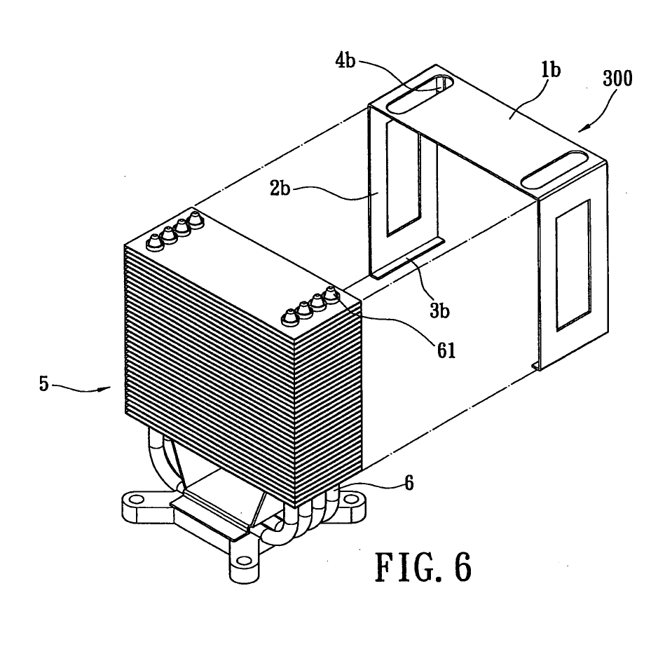

Reference is made to FIG. 6, which shows the fastening board for cooling fins 300 of the third embodiment of the present invention. The difference between the third embodiment and the first embodiment is that the board body 1b has two side boards 2b. The two side boards 2b are respectively at the two opposite sides of the board body 1b. The two side boards 2b extend downwards from the sides of the board body 1b. Two fasteners 3b are respectively located at the ends of the two side boards 2b. The board body 1b covers on the top of the set of cooling fins 5. The fasteners 3b fasten to the end of the set of cooling fins 5. The fastening portions 4 extend from the two sides of the side board 2b.

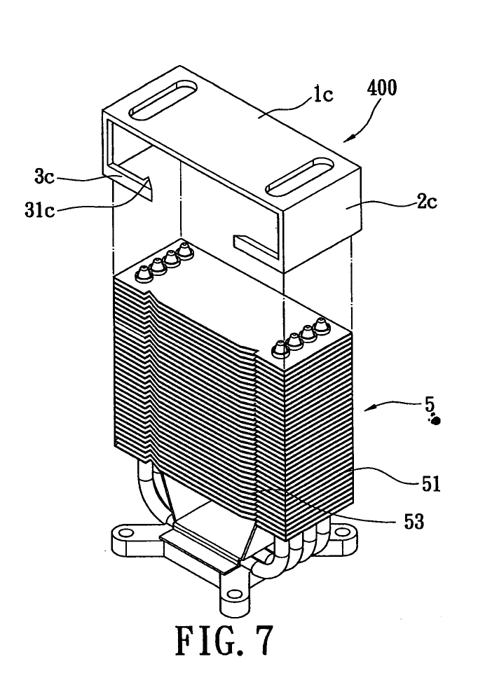

Reference is made to FIG. 7, which shows the fastening board for cooling fins 400 of the fourth embodiment of the present invention. The difference between the fourth embodiment and the first embodiment is that the board body 1c has two side boards 2c. The two side boards 2c are respectively at the two opposite sides of the board body 1c. The two side boards 2c extend downwards from the sides of the board body 1c. A plurality of fasteners 3c is respectively located at the two sides of the two side boards 2c. The end of the fastener 3c has a hook portion 31c. The board body 1c covers on the top of the set of cooling fins 5. The two opposite sides of the cooling fins 51 of the set of the cooling fins 5 respectively have two concave ditches 53. The fasteners 3c fasten to the concave ditches 53.

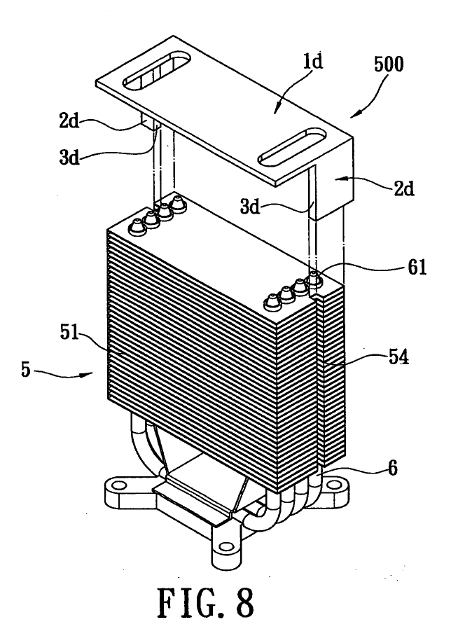

Reference is made to FIG. 8, which shows the fastening board for cooling fins 500 of the fifth embodiment of the present invention. The difference between the fifth embodiment and the first embodiment is that the board body 1d has two side boards 2d. The two side boards 2d are respectively at the two opposite sides of the board body 1d. The two side boards 2d extend downwards from the sides of the board body 1d. Two fasteners 3d are respectively located at the sides of the two side boards 2d. The board body 1d covers on the top of the set of cooling fins 5. The two opposite sides of the cooling fins 51 of the set of the cooling fins 5 respectively have two concave ditches 54. The fasteners 3d fasten to the concave ditches 54.

The fastening board for cooling fins can firmly fasten to a set of cooling fins to prevent the last cooling fin of the set cooling fins from coming off.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A fastening board for cooling fins, used for fastening a set of cooling fins onto a pipe, the set of cooling fins are composed of a plurality of cooling fins and there are a plurality of gaps that each gap is located between the two adjacent cooling fins, comprising:
a board body covering on a top of the set of cooling fins;
a plurality of side boards respectively located at two opposite sides of the board body; and
a plurality of fasteners respectively located at the side boards, wherein the fasteners respectively fasten to the cooling fins.

2. The fastening board for cooling fins as claimed in claim 1, wherein the board body has at least one opening.

3. The fastening board for cooling fins as claimed in claim 1, wherein the side board has at least one cooling hole.

4. The fastening board for cooling fins as claimed in claim 1, wherein the fasteners respectively fasten to a gap of the cooling fins.

5. The fastening board for cooling fins as claimed in claim 1, wherein the fasteners are respectively located at end of the side boards.

6. The fastening board for cooling fins as claimed in claim 1, wherein sides of the board body have a plurality of fastening portions for positioning the board body to the set of cooling fins.

7. A fastening board for cooling fins, used for fastening a set of cooling fins onto a pipe, comprising:
a board body covering on a top of the set of cooling fins;
two side boards respectively located at two opposite sides of the board body; and
two fasteners respectively located at ends of the two side boards;
wherein the board body covers on the top of the set of cooling fins, and the two fasteners fasten to an end of the set of cooling fins.

8. The fastening board for cooling fins as claimed in claim 7, wherein the board body has at least one opening.

9. The fastening board for cooling fins as claimed in claim 7, wherein the side board has at least one cooling hole.

10. The fastening board for cooling fins as claimed in claim 7, wherein sides of the board body have a plurality of fastening portions for positioning the board body to the set of cooling fins.

11. A fastening board for cooling fins, used for fastening a set of cooling fins onto a pipe, the set of cooling fins are composed of a plurality of cooling fins and two opposite sides of the cooling fins respectively have a plurality of concave ditches, comprising
a board body covering on a top of the set of cooling fins;
two side boards respectively located at two opposite sides of the board body; and
a plurality of fasteners respectively located at sides of the two side boards;
wherein the board body covers on the top of the set of cooling fins, and the fasteners fasten to the concave ditches of the cooling fins.

12. The fastening board for cooling fins as claimed in claim 11, wherein the board body has at least one opening.

13. The fastening board for cooling fins as claimed in claim 11, wherein the side board has at least one cooling hole.

14. The fastening board for cooling fins as claimed in claim 11, wherein sides of the board body have a plurality of fastening portions for positioning the board body to the set of cooling fins.

15. The fastening board for cooling fins as claimed in claim 11, wherein the fasteners are respectively located at two opposite sides of the two side boards.
